(19) United States
(12) Patent Application Publication
(10) Pub. No.: US 2017/0090144 A1
(43) Pub. Date: Mar. 30, 2017

(54) OPTICAL MOUNT ASSEMBLY WITH ASSEMBLY-FRIENDLY ADHESIVE CONNECTION

(71) Applicant: JENOPTIK Optical Systems GmbH, Jena (DE)

(72) Inventors: Torsten ERBE, Jena (DE); Frank Pacholik, Jena (DE); Juergen Weise, Jena (DE); Birgit Massino, Jena (DE); Joerg-Peter Schmidt, Amt Wachsenburg (DE)

(21) Appl. No.: 15/272,765

(22) Filed: Sep. 22, 2016

(30) Foreign Application Priority Data
Sep. 30, 2015 (DE) DE102015116590.2

(51) Int. Cl. G02B 7/02

(52) U.S. Cl. CPC G02B 7/026; G02B 7/025

(57) ABSTRACT

Optical mount assembly comprising a lens mount with a plurality of retaining arms (3.1) which are arranged in a rotationally symmetrical manner and with a lens (1) which is connected via its cylindrical circumferential surface (1.1) to the retaining arms (3.1) in each instance via at least two adhesive areas (4.1) within a joint area (4). The retaining arms (3.1) have within the joint area (4) a slot structure with at least one slot (5.2) which is filled with adhesive during assembly and proceeding from which the adhesive is transported into the adhesive gap (6) and which forms the adhesive areas (4.1).

### RELATED APPLICATIONS

The present application claims priority benefit of German Application No. DE 10 2015 116 590.2 filed on Sep. 30, 2015, the contents of which are incorporated by reference in their entirety.

### FIELD OF THE INVENTION

The invention is directed to amount assembly comprising a lens mount and an optical lens held radially therein via an adhesive connection.

### BACKGROUND OF THE INVENTION

A mount assembly of this kind is known generically from U.S. Pat. No. 3,601,343 A.

Low-stress mounting of optical elements is a core problem in the development of high-power objectives. Forces introduced into the mount by dynamic loads and thermal loads are to a great extent not transmitted to an optical element that is held under low stress so that that this optical element itself does not undergo any deformation, stress or misalignment.

A number of arrangements in which an optical element such as a lens is held in a mount under low stress are known from the prior art.

U.S. Pat. No. 7,471,470 B2 discloses a lens mount in which the lens is held radially via radially preloaded retaining arms (referred to therein as bracing struts) extending in axial direction of the lens mount. Axially, the lens rests by an end face on an annular collar which is formed at the same mount part as the retaining arms. During different thermal expansions between the lens and the lens mount, a relative movement is brought about compulsorily between the lens and the annular collar. To prevent this relative movement from leading uncontrolledly to a decentering of the lens, evenly distributed radial forces which keep the lens centered act via the retaining arms through the permanent preloading. However, these retaining forces also lead compulsorily to stresses in the lens and, therefore, to an impairment of the optical imaging quality of the lens, which cannot be tolerated in many applications.

In a mount described in EP 1 107 034 A2 for low-deformation support of an optical element, the optical element is defined axially by three uniformly distributed supports, is received in the mount so as to be centered radially through three circumferential gaps which are milled in a dimensionally stable manner and is fixed and sealed with circumferential bonding to the radially extending lateral surfaces. However, because the mount has no arrangement for compensating thermal expansions, a low-stress holding of the optical element cannot be assumed in this mount.

DE 41 13 956 C2 describes a lens mount in which are received optical elements with two plane side surfaces. This is carried out via laterally glued connection elements which are supported and glued in recesses of the lens mount. The gluing between the optical element and the connection elements has a certain elasticity which can compensate for an axial expansion difference. The optical element is guided at surfaces of the connection element. Steps which take into account a radial expansion difference are not described.

DE 10 2014 102 715 B3 describes a low-stress mount assembly with a monolithic mount ring having a plurality of retaining arms which are arranged concentrically around the axis of symmetry of the mount ring such that their free ends extend in axial direction. An element is received in the mount ring at the free ends, this element axially contacting three of the retaining arms by its end face, while it communicates radially at a circumferential surface with the remaining free ends in a bonding connection that is not preloaded. To compensate for axial movements of the element, the retaining arms have elasticity in radial direction.

In U.S. Pat. No. 3,601,343 A, cited above, a lens, for example, is received in a low-stress manner in a mount which is formed from a stable mount ring (referred to therein as base) and an annular part which is connected to the inner surface of the mount ring. Proceeding from an end face, the annular part is provided with slots at regular intervals such that a shared collar remains, so that tongue-like retaining arms which are separated by gaps are formed adjoining the collar. The free ends of the retaining arms are fixedly connected at their inner surfaces to the circumference of the received lens. The retaining arms act like leaf springs that are clamped in at one side so that the body held between the free ends can radially expand differently relative to the mount ring such that an axial movement or a rotation cannot occur. An advantage of this mount consists in that the annular part is produced from a sheet metal strip in which the retaining arms are formed by cutting or stamping before it is deformed into an annular shape. The finished annular part is glued, soldered or welded in the mount ring or connected to it in some other manner. The lens or an annular body, e.g., a stator, is also to be connected to the free ends of the retaining arms. Of the stated alternatives for a lens, only an adhesive connection would be considered. No particulars are given as to carrying this out. Accordingly, it must be assumed that the outer diameter of the lens and the inner diameter of a circle formed by the free ends of the retaining arms have a slightly different diameter so that an adhesive gap which is filled with adhesive in axial direction proceeding from the free end results between the circumferential surface of the lens and the free ends. The size of the adhesive area resulting under a retaining arm in each instance is given chiefly by the amount of adhesive and the viscosity of the adhesive. More adhesive areas which can then be formed so as to be smaller to provide a comparatively equally large total adhesive surface area of the adhesive connection formed by all of the adhesive areas can only be achieved with a greater quantity of retaining arms.

It is the object of the invention to improve a lens carrier according to U.S. Pat. No. 3,601,343 A, cited above, in such a way that the adhesive connection is formed by a greater quantity of adhesive areas without increasing the quantity of retaining arms.

This object is met in an optical mount assembly comprising a lens mount with an axis of symmetry and a plurality of retaining arms which are arranged in a rotationally symmetrical manner and which are separated from one another by a gap, and with a lens with a cylindrical circumferential surface. The retaining arms are axially oriented in each instance toward the free end which is limited by an end face and, together with the circumferential surface, form a joint area. The end face and the retaining arms define an adhesive gap with an adhesive gap width. The lens and lens mount are connected within the joint area via at least two adhesive areas. Inside the joint area, the retaining arms have a slot structure with at least one slot. At least the first of the slots extends at least partially axially, i.e., the direction in which it extends has an axial component. It has a first slot end and a second slot end, the first slot end communicates with the end face, and the second slot end is located outside of the joint area. Due to the fact that the at least one slot extends beyond the joint area toward the collar, not only are the adhesive areas separated from one another, but the retaining arm is tangentially elastic.

The at least one slot has a slot width that is greater than the width of the adhesive gap. It defines two adhesive areas

The first slot end of the first of the slots advantageously communicates with the end face via a funnel-shaped slot neck into which the outlet of an apparatus for introducing the adhesive can be inserted for filling the slot with adhesive.

To increase the tangential elasticity of the retaining arms, at least one of the slots advantageously opens into an adjoining widened slot end which is located outside of the joint area.

It is advantageous when the slot structure has further slots proceeding from the funnel-shaped slot neck so that there are more than two adhesive areas.

The same result is achieved when the first of the slots branches into a plurality of slots.

### BRIEF DESCRIPTION OF THE DRAWINGS

A mount assembly according to the invention is described more fully in the following using embodiment examples referring to the drawings. The drawings show:

FIG. 1a is a perspective view of a first embodiment example of a mount assembly;

FIG. 1b is a side-section of one of the retaining arms of the first embodiment example according to FIG. 1a;

FIG. 2 is a side-section of one of the retaining arms of a second embodiment example of a mount assembly;

FIG. 3 is a side-section of one of the retaining arms of a third embodiment example of a mount assembly;

FIG. 4 is a side-section of one of the retaining arms of a fourth embodiment example of a mount assembly;

FIG. 5 is a side-section of one of the retaining arms of a fifth embodiment example of a mount assembly;

FIG. 6 is a side-section of one of the retaining arms of a sixth embodiment example of a mount assembly; and

FIG. 7 is a side-section of a further mount assembly.

### DETAILED DESCRIPTION OF THE DRAWINGS

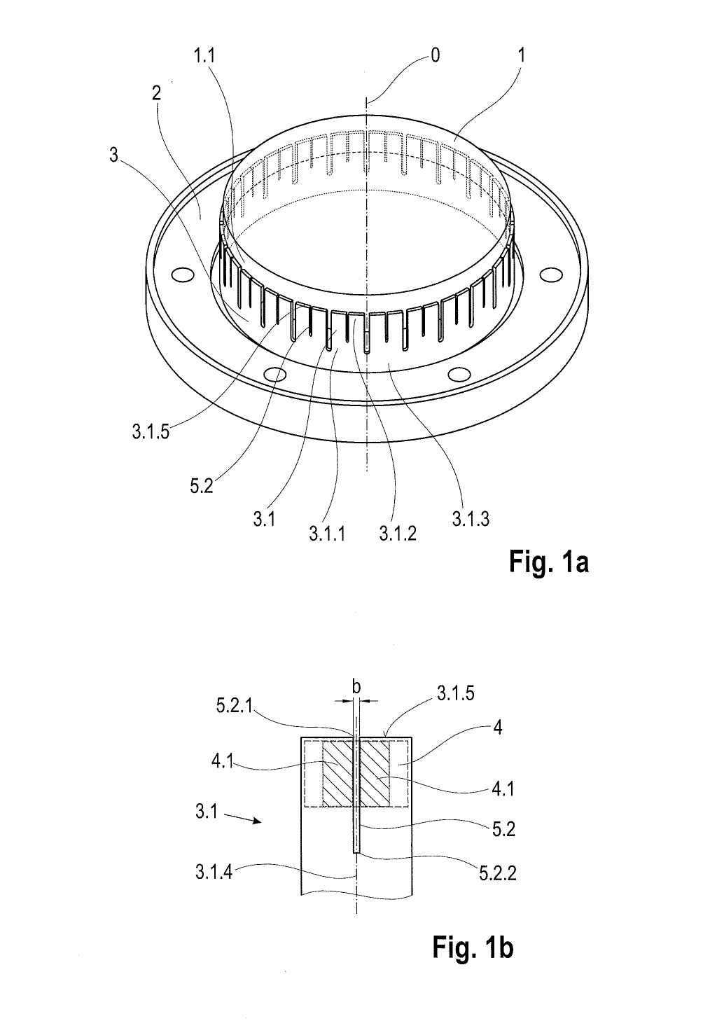

As is shown in FIG. 1a, amount assembly according to the invention basically comprises a lens mount and a lens 1 with a cylindrical circumferential surface 1.1, which lens 1 is held in the lens mount. The lens mount has an axis of symmetry 0 and a plurality of retaining arms 3.1 which are arranged in a rotationally symmetrical manner.

As in the prior art, the lens mount is preferably divided into a stiff outer mount ring 2 with the axis of symmetry 0 and an inner mount ring 3 which is arranged coaxial to the latter and at which the retaining arms 3.1 are formed at a collar 3.1.3. The outer mount ring 2 preferably has an inner circumferential surface with an inner diameter contacted by the inner mount ring 3. However, the outer mount ring 2 and the inner mount ring 3 can also be connected to one another discretely or monolithically, e.g., via elastic connection structures. Within the meaning of this description, the inner mount ring 3 also means ring segments which are arranged annularly and not directly connected to one another. The retaining arms 3.1 have in each instance a fixed end 3.1.1 via which they are monolithically connected to the collar 3.1.3, and a free end 3.1.2. The retaining arms 3.1 are axially oriented at least in a joint area 4 adjoining the free end 3.1.2. The joint area 4 is formed in each instance by an inner partial surface of the retaining arm 3.1 which adjoins an end face 3.1.5 at the free end 3.1.2 and a partial surface of the outer circumferential surface 1.1 located opposite to this partial surface. Together, the partial surfaces form within the joint area 4 an adhesive gap 6 with an adhesive gap width f. The retaining arms 3.1 are bonded to the circumferential surface 1.1 of the lens 1 in each instance within the joint area 4 partially via at least two adhesive areas 4.1. The at least two adhesive areas 4.1 are formed when the lens 1 is glued into the lens mount contingent upon a slot structure according to the invention which is located in each instance within the joint area 4 in the retaining arm 3.1. The slot structures comprise at least one slot 5.2. At least the first of the slots 5.2 extends at least partially axially so that an adhesive added proceeding from the free end 3.1.2 fills the first of the slots 5.2 under force of gravity. It has a first slot end 5.2.1 communicating with the end face 3.1.5 and a second slot end 5.2.2 which is located outside of the joint area 4. In an advantageous manner, the first slot end 5.2.1 opens into a funnel-shaped slot neck 5.1 in which the outlet of an apparatus for introducing the adhesive can be inserted for filling the first of the slots 5.2 with adhesive from axial direction or preferably in an assembly-friendly manner from radial direction. Advantageously, the adhesive is introduced in an amount such that it can be received by the at least one slot 5.2. Proceeding from there, the adhesive is transported into the adhesive gap 6 between the retaining arms 3.1 and the circumferential surface 1.1 and forms the adhesive areas 4.1. The slot width b of the at least one slot 5.2 and the adhesive gap width f are selected depending on the viscosity of the adhesive in such a way that the adhesive runs easily into the at least one slot 5.2 and is transported from there as completely as possible through capillary action into the adhesive gap 6. In every case, the slot width b is greater than the adhesive gap width.

As is well known, the size of the resulting adhesive areas 4.1 depends on the characteristics of the adhesive, particularly the viscosity, and the adhesive gap width f.

In order to provide a stable adhesive connection between two parts to be joined, in this case lens mount and lens 1, the total surface area of the adhesive connection formed by all of the adhesive areas 4.1 should be as large as possible. With respect to shrinkage in general or also if shrinkage is negligible and during thermal loading of the parts to be joined having different thermal expansion coefficients such as in the case of a lens mount and a lens 1, it is expedient to form the total surface area of the adhesive connection through a plurality of smaller adhesive areas 4.1 instead of only a few larger adhesive areas 4.1.

With a generic lens mount having no slot structures in the retaining arms 3.1, a quantity of adhesive areas 4.1 can be formed in principle corresponding to the quantity of retaining arms 3.1, which is why it is only with an increasing quantity of retaining arms 3.1 that a like increasing quantity of adhesive areas 4.1 can be provided. The adhesive is applied to the end faces 3.1.5 of the retaining arms 3.1 and proceeding therefrom is received in the adhesive gap 6 via a penetration depth determined by the capillarity. The penetration depth and, therefore, the size of the adhesive area 4.1 that is formed within the joint area 4 can—with the exception of the adhesive gap width f—be influenced by the choice of adhesive. Accordingly, according to the prior art, only one adhesive area 4.1 is formed per retaining arm 3.1, the size of this adhesive area 4.1 being limited by the capillarity and the length of the end face 3.1.5.

When the retaining arms 3.1 have a slot structure according to the invention, the distribution of the adhesive in the joint area 4 does not take place in only one direction proceeding from the end face 3.1.5 of the retaining arm 3.1 but in at least two directions proceeding from the at least one slot 5.2 so that comparatively at least double the quantity of adhesive areas 4.1 is provided.

Depending on the extension of the at least one slot 5.2, the distribution can be carried out from virtually any place within the joint area 4. While adhesive areas 4.1 which form a strip of only limited width along the end face 3.1.5 of the retaining arm 3.1 with an adhesive of comparatively high viscosity in a retaining arm 3.1 without a slot structure also form strips with a limited width in this case, they can be distributed in any way along the course of the slot 5.2 in the joint area 4 due to the fact that the course of the slot 5.2 may be virtually freely selected.

Beyond this, as a result of the separation of the retaining arm 3.1 along the at least one slot 5.2, virtually no adhesive area 4.1 is formed between the lens 1 and the retaining arm 3.1 over the width of this slot 5.2, but rather only in the adjoining areas so that an adhesive area 4.1 results in both edge areas adjoining the slot 5.2.

In order for the at least one slot 5.2 to be filled with adhesive before or while it is transported into the adhesive gap 6, the slot width b of the at least one slot 5.2 is greater than the adhesive gap width f of the adhesive gap 6.

The retaining arms 3.1 advantageously have a contour which is axisymmetric to a center line 3.1.4 and are at least partially—compulsorily in the joint area 4—arranged parallel to the axis of symmetry 0. The outer contour of the retaining arms 3.1 can be selected in any way, but so as to be axisymmetric, so as to have a sufficiently wide joint area 4 on the one hand and, on the other hand, to have a width below the joint areas 4, which is advantageous for the required tangential elasticity of the retaining arms 3.1.

As is known, the width below the joint area 4 can be reduced through lateral recesses. But this can also be achieved in connection with a slot structure according to the invention in that at least one of the slots 5.2 opens into a widened slot end 5.3.

All of the above-mentioned features of a mount assembly according to the invention apply to all of the embodiments. The embodiment examples shown in the following differ essentially only through different constructions of the slot structures. The configurations of the geometry of the retaining arms 3.1 can be combined arbitrarily and can be interchanged with other embodiment examples.

For constructions in which the center lines 3.1.4 of the retaining arms 3.1 extend completely parallel to the axis of symmetry 0, the inner mount ring 3 can advantageously be produced from a rectangular sheet metal strip which has been deformed into the shape of a cylinder. Accordingly, the retaining arms 3.1 can be cut out and the slot geometry can be introduced before shaping by means of cutting, etching or stamping the plane sheet metal strip. The inner mount ring 3 is advantageously shaped in such a way that in the low-stress state following the deformation of the sheet metal strip its outer diameter is larger than the inner diameter of the outer mount ring 2 and a gap remains between the two ends of the sheet metal strip. During assembly, i.e., when placing the inner mount ring 3 against the inner circumferential surface of the outer mount ring 2, the inner mount ring 3 is clamped by compressing the gap. The inner mount ring 3 subsequently contacts the inner circumferential surface and, in an advantageous manner, does not completely relax so that it is held in the inner mount ring 3 by frictional engagement. Instead, it can be held additionally by adhesive so as to be relaxed or partially compressed. Because the inner mount ring 3 is provided with slots, the tension possibly existing in the collar 3.1.3 of the inner mount ring 3 is not transmitted to the free ends 3.1.2 of the retaining arms 3.1.

FIGS. 1a and 1b show a first embodiment example for a lens mount in which, symmetrically with respect to the center line 3.1.4 in each instance, the slot structure comprises only one slot 5.2 along the center line 3.1.4. The lens 1 is inserted into the lens mount, and the circumferential surface 1.1 of the lens 1, together with the opposite free end 3.1.2 of a retaining arm 3.1, respectively, forms a joint area 4 which ends above the second slot end 5.2.2 of the one slot 5.2 so that the slot structure does not lie completely within the joint area 4. Two resulting adhesive areas 4.1 should preferably have a square surface area in each instance. In opposition to tangential forces brought about by a differing thermal expansion of the material of the lens 1 and of the lens mount, the retaining arm 3.1 is more flexible over the length of the one slot 5.2, i.e., more tangentially elastic, than in the areas without slots.

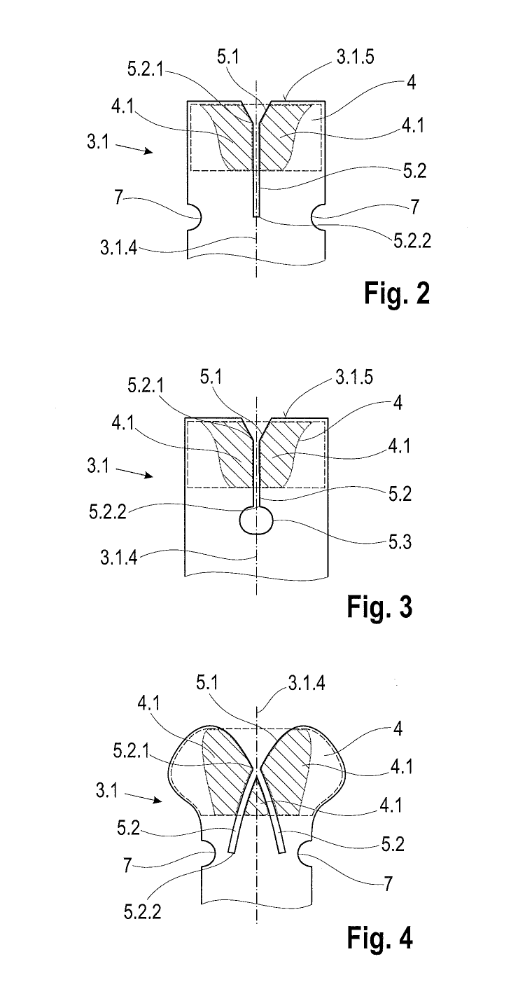

A second embodiment example, shown in FIG. 2, differs from the first embodiment example in that the slot 5.2 communicates with the end face 3.1.5 via a funnel-shaped slot neck 5.1 in the form of a notch. To reduce the tangential elasticity of the retaining arm 3.1, two lateral recesses 7 are provided below the joint area 4 at the level of the second slot end 5.2.2.

In a third embodiment example, as is shown in FIG. 3, the second slot end 5.2.2 opens into a widened slot end 5.3 which reduces the tangential elasticity of the retaining arm 3.1 instead of lateral recesses 7.

According to a fourth embodiment example, shown in FIG. 4, the slot structure has two slots 5.2 proceeding from the funnel-shaped slot neck 5.1, and the outer contour has been adapted in a freeform manner. Three adhesive areas 4.1 are formed.

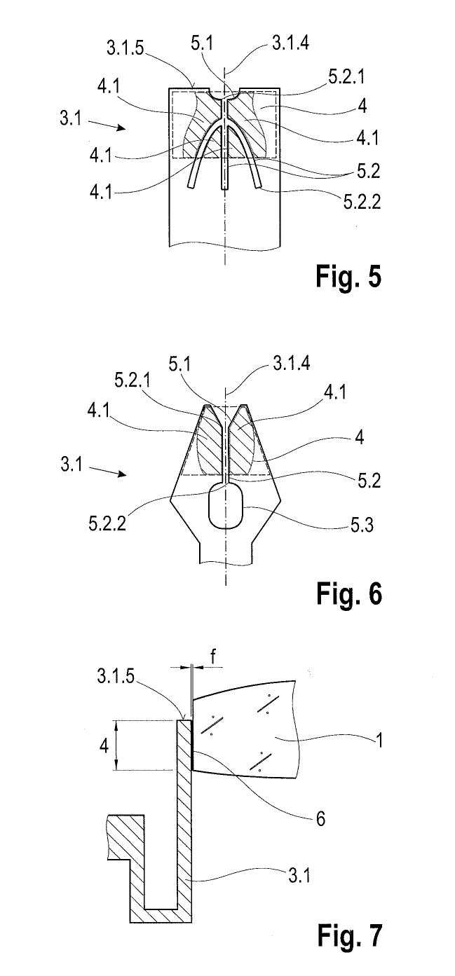

According to a fifth embodiment example, shown in FIG. 5, the first of the slots 5.2 branches into three slots 5.2 so that four adhesive areas 4.1 are formed so as to be distributed within the joint area 4, and the tangential elasticity is determined by a three-fold quantity of slots.

A sixth embodiment example, see FIG. 6, once again shows an example in which, owing to a widened slot end 5.3., the tangential elasticity of the retaining arm 3.1 is reduced in a wider area resulting from the outer contour.

As an alternative to a lens mount having retaining arms 3.1 according to FIG. 1a which have an axial orientation along their entire length, FIG. 7 shows a section through a lens mount in which the retaining arms 3.1 partially also have radial portions to show that the retaining arms 3.1 need only be axially oriented in a portion adjoining the end face 3.1.5 of the free end 3.1.2 to form a joint area 4 with the circumferential surface 1.1 of the lens 1.

### LIST OF REFERENCE CHARACTERS

0 axis of symmetry
1 lens
1.1 circumferential surface
2 outer mount ring
3 inner mount ring
3.1 retaining arm
3.1.1 fixed end
3.1.2 free end
3.1.3 collar
3.1.4 center line
3.1.5 end face
4 joint area
4.1 adhesive area
5.1 funnel-shaped slot neck
5.2 slot
5.2.1 first slot end
5.2.2 second slot end
5.3 widened slot end
6 adhesive gap
7 lateral recess
b slot width
f adhesive gap width

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. An optical mount assembly comprising a lens mount with an axis of symmetry, a plurality of retaining arms arranged in a rotationally symmetrical manner and which are separated from one another by a gap, a lens with a cylindrical circumferential surface, wherein said retaining arms have a free end which is limited by an end face, said retaining arms each being axially oriented toward said free end and arranged with respect to the circumferential surface so as to form a joint area, said joint area forming an adhesive gap with a gap width, said lens mount and lens being connected by means of adhesive via at least one adhesive area, said retaining arms have, within the joint area, a slot structure with at least one slot, at least a first of said slots extending at least partially axially, said at least said first of said slots having a first slot end and a second slot end, wherein the first slot end communicates with said end face, and the second slot end is located outside of the joint area, said at least one slot having a slot width that is greater than the adhesive gap width and defines two adhesive areas.

2. The optical mount assembly according to claim 1, wherein the first slot end of the first of the slots communicates with the end face via a funnel-shaped slot neck into which an outlet of an apparatus for introducing the adhesive can be inserted for filling the slot with adhesive.

3. The optical mount assembly according to claim 1, wherein at least one of the slots opens into an adjoining widened slot end which is located outside of the joint area.

4. The optical mount assembly according to claim 2, wherein at least one of the slots opens into an adjoining widened slot end which is located outside of the joint area.

5. The optical mount assembly according to claim 3, wherein the slot structure has further slots proceeding from the funnel-shaped slot neck.

6. The optical mount assembly according to claim 4, wherein the slot structure has further slots proceeding from the funnel-shaped slot neck.

7. The optical mount assembly according to claim 1, wherein said first of the slots branches into a plurality of slots.

8. The optical mount assembly according to claim 2, wherein said first of the slots branches into a plurality of slots.

9. The optical mount assembly according to claim 3, wherein said first of the slots branches into a plurality of slots.
